(19) United States
(12) Patent Application Publication
(10) Pub. No.: US 2006/0074946 A1
(43) Pub. Date: Apr. 6, 2006

(54) Point of view distributed agent methodology for network management

(75) Inventor: Nguyen K. Pham, Mc Donough, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Performance IT, Atlanta, GA (US)

(21) Appl. No.: 11/236,469

(22) Filed: Sep. 27, 2005

Related U.S. Application Data
(60) Provisional application No. 60/613,838, filed on Sep. 27, 2004.

(51) Int. Cl. G06F 17/30

(52) U.S. Cl. 707/100

(57) ABSTRACT

The invention relates to a system and method for monitoring and diagnosis of issues experienced from a client system's point of view. More particularly, the invention relates to a system and method for monitoring and diagnosis of issues experienced from a client system relating to synthetic or observed transactions involving the client system, or overall performance of the client system, taking into account that the system is member of a larger set of similar systems.

This application claims the benefit, pursuant to 35 U.S.C. §119(e), of U.S. Provisional Patent Application entitled “POINT OF VIEW DISTRIBUTED AGENT METHODOLOGY FOR NETWORK MANAGEMENT,” filed on Sep. 27, 2004, and assigned Ser. No. 60/613,838, the disclosure of which is incorporated herein by reference in its entirety.

### FIELD OF THE INVENTION

The invention relates to a system and method for monitoring and diagnosis of issues experienced from a client system's point of view. More particularly, the invention relates to a system and method for monitoring and diagnosis of issues experienced from a client system relating to synthetic or observed transactions involving the client system, or overall performance of the client system, taking into account that the system is member of a larger set of similar systems.

### BACKGROUND OF THE INVENTION

A client system is defined as set of software applications running on a single operating system (real or virtual) that communicates to with a central server application, either locally or over a computer network. Typically, client systems can be grouped together both by hardware specifications and by designated use. These groupings may be very large, scaling into the thousands.

A general assumption is that since most client systems can be placed logically in a group of like peers, they should behave relatively the same. Issues arise when a set of client systems deviate from the norm. Unlike general network monitoring where devices vary greatly from one device to another, monitoring of clients allows a unique opportunity to dynamically describe a norm amongst the group. The norm in many cases may stray from the ideal; however, systems which are outside the norm in the uniform group should be considered as potential points of failure. Various factors contribute to deviations in systems from the group norm, including variations in hardware, software, configuration, and usage. Troubleshooting systems outside the norm typically falls in the realm of determining which of these underlying causes contributes to non-desirable behavior. However, the vast number of variables involved makes this determination very difficult.

A common debugging technique is to attempt to determine what the alerting systems have in common. This is typically done through hypothesis and trial and error, as a plurality of metrics on the order of hundreds or thousands may be available for each client system.

Further complicating the monitoring and diagnostic effort, the advent of network computing has moved vital software applications away from client systems and onto servers located at remote locations. The location of the server application may be within a corporate data center or at a remote data center. Typically, there exists a complex network involving switches, routers, and various other access devices that connect a client system to the remote servers. Issues related to any client's usage of a server-based application may arise from any one of three major components: 1) the client system, 2) the network connecting the client system to the remote application, and 3) the remote application itself.

Further, data collection and monitoring of individual major components above may not yield desired results if not done from the client perspective. Additionally, a simulated synthetic transaction from a representative test system located in the client network may not be sufficient without accounting for the actual client systems. Specific usage patterns and minor environmental differences on client systems may yield sampled synthetic test results inaccurate. Since issues with client/server software may impact multiple and varied users, there is a need for rapid identification of issues and determination of impact.

Due to the fact that computer networks are implemented using varied topologies, which may create situations where one client system experiences a difference in observed behavior than another system, it is necessary to collect data from multiple representative systems. To do so, an agent must be deployed and made operational on multiple representative systems or universally.

Managing the collection of data from multiple sources leads to issues involving 1) mass coordination of activities from non-reliable, transient agents, 2) efficient aggregation of data, and in a networking environment, 3) the impact of bandwidth utilization when taken in mass. Further, since the host systems are client systems, the agent must be aware of its operating environment and run without creating a negative impact on the host system.

Modern network monitoring systems are capable of monitoring individual components for their general health. These systems typically are not capable of providing assessment of the number and type of client systems affected at any given moment. Such data can be critical to responders when issues arise for the purpose of prioritization and determination of blame.

The concept of monitoring client systems is prevalent, but with the advent of network computing the operating environment of the client system becomes only one factor in the perception of lack of performance by clients. The network connecting the client's system to the remote server application, the remote server application itself, as well as the client's operating environment, could each be contributing causes to the client's perception of poor performance. Unfortunately, in most modern organizations, diagnosis and repair of each of the above three areas may involve different support groups and expertise—help desk support if the issue is the client's operating environment, network specialists for networking problems, and application developers and system administrators for server application problems.

Some monitoring systems exist which monitor transactions from the client perspective through the simulation of a synthetic transaction. The systems reside on a representative client system or on systems placed in the network at various locations. Unfortunately, because these systems are not coordinated with one another and data collected from them is not correlated between systems, they are only able to provide simple alerts based on response time without 1) assessment of blame, 2) impact (including number of users affected), 3) verification from other clients, and 4) cross-client diagnostic information, including commonalties. Further, these systems are not ideal for running on actual client systems for purposes of transaction monitoring, because they do not take into account the current operating environment of the client system to determine if sufficient resources exist to operate without negatively impacting the client. For this reason, these systems are typically deployed on representative and not actual client systems.

In view of the foregoing, there is a need for a system and method for monitoring and diagnosis of issues experienced from a client system relating to synthetic or observed transactions involving the client system, or overall performance of the client system, taking into account that said system is a member of a larger set of similar systems, wherein doing so does not negatively impact clients, and wherein the activity of data collection, aggregation, blame assessment, and correlation is done in a coordinated and efficient manner. Since client systems are often found in extremely large number, the system's architecture must be able to provide coverage monitoring (beyond simple representative samples) and be able to compare vast amounts of hardware, software, configuration, and usage metrics to assist in the determination of underlying causes.

### SUMMARY

The invention relates to a systems and methods for monitoring and diagnosis of issues experienced from a client system's point of view. More particularly, the invention relates to a system and method for monitoring and diagnosis of issues experienced from a client system relating to synthetic or observed transactions involving the client system, or overall performance of the client system, taking into account that said system is member of a larger set of similar systems.

Aspects of the present invention comprise a system for the client-based perspective monitoring and diagnosis of issues relating to a client system. The system comprises a central server, wherein a point-of-view agent aggregator resides at the central server, the point-of-view agent aggregator maintains communication and aggregates data that is received from point-of-view agents and at least one client system, wherein the client system is in communication with the central server. A plurality of point-of-view agents is provided, wherein at least one agent resides within at least one client system and is in communication with the central server, the point-of-view agent being configured to monitor the client system's operations from the client system's perspective and transmit the acquired monitored data to the central server and a point-of-view agent coordinator. Further, a point-of-view agent coordinator, either residing locally at the central server or at a remote server that is in communication with the central server and the plurality of point-of-view agents, wherein the point-of-view agent coordinator transmits control commands to the plurality of point-of-view agents.

Further aspects of the present invention comprise a repository residing at the central server, wherein the repository is in communication with the point-of-view aggregator and an analytical engine, data transmitted from the plurality of point-of-view agents to the point-of-view aggregator being stored within the repository. Also, an analytical engine is provided, wherein the analytic engine resides at the central server, the analytical engine being in communication with the point-of-view aggregator, the analytical engine using the data acquired from the point-of-view agents to determine client system baselines, identify deviant client systems, the determination of commonalities between deviant client systems, and the determination of the commonalities between deviant client systems and non-deviant client systems. The analytical engine assigns respective client systems to groups based upon runtime, environmental, and use criteria. Upon the detection of a deviant client system an alarm function is initiated.

A further aspect of the present invention relates to a method for the client-based perspective monitoring and diagnosis of issues relating to a client system. The method comprises the steps of distributing a plurality of point-of-view agents on at least on client system, wherein the point-of-view agents monitor predetermined operations of the client system and coordinating the collection of the client system monitoring data acquired by the point-of-view agents. The method further comprises the steps of confirming the validity of the acquired client system data, analyzing the acquired data in order to ascertain any commonalities that may exist between the data of differing client systems, and assigning respective client systems to groups based upon runtime, environmental, and use criteria. Furthermore, the method comprises the steps of identifying a deviant client system in the event that the acquired data in regard to the client system determines that the client system behavior is deviant and initiating an alarm function that identifies the deviant client system.

Within further aspects of the method, deviant client systems can automatically be detected and the commonalities between deviant systems and non-deviant systems can be determined. Also, the step of determining baselines for the purpose of assisting in detecting deviation within a client system is provided, wherein, baselines are composed of environmental, numerical runtime, and runtime components. Each client system to a group baseline and thereafter the commonalities, and differences in commonalities between deviant and non-deviant client systems is determined.

A yet further aspect of the present invention comprises a computer program product that includes a computer readable medium that is usable by a processor. The medium having stored thereon a sequence of instructions that when executed by a processor causes the data unit processor to execute the steps of coordinating the collection of the client system monitoring data acquired by point-of-view agents and assigning respective client systems to groups based upon runtime, environmental, and use criteria. Further, the computer program product confirms the validity of the acquired client system data, analyzes the acquired data in order to ascertain any commonalities that may exist between the data of differing client systems, identifies a deviant client system in the event that the acquired data in regard to the client system determines that the client system behavior is deviant, and initiates an alarm function that identifies the deviant client system.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1 is a diagram of a prior art network management system.

FIG. 2 is a diagram of an embodiment of the present client-based point-of-view network monitoring system

FIG. 3 is a flow chart illustrating a preferred function of the present invention.

FIG. 4 is a diagram illustrating preferred component features of aspects of the present invention.

FIG. 5 is a diagram illustrating the detail of a point-of-view agent that can be utilized within embodiments of the present invention.

### DETAILED DESCRIPTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

Aspects of the present invention relate to a next generation application, network, and infrastructure management platform based upon the novel concept of Point-of-View (POV) agents. Further, the invention relates to a grid-based software solution that provides the foundation for building a truly fault tolerant, super scalar, network monitoring product that can leverage the power of an organization's client systems to increase network and business reliability.

Traditionally, network management systems (NMS) utilize centralized monitoring components in order to assess the health of the network. The architecture of the present invention employs POV client system monitoring agents that are widely distributed to a variety of end-points (e.g., desktops, servers, mobile devices, kiosks, embedded devices, workstations, etc).

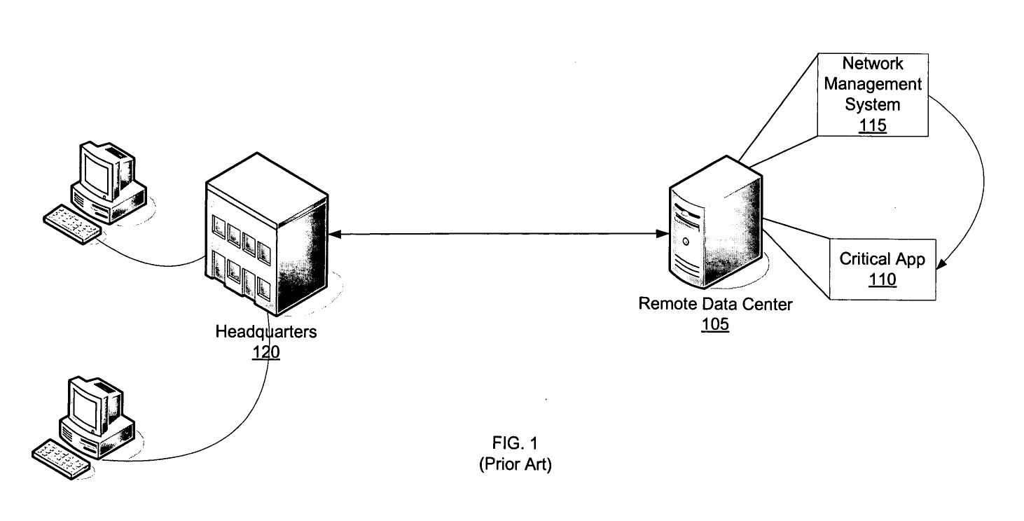

This new monitoring methodology provides an exceptional mechanism for providing the increased visibility and a real-time view of a network. As illustrated in FIG. 1, traditional NMSs are designed to evaluate a network from the perspective of the infrastructure itself. More and more businesses are moving their primary equipment to data centers and using virtual private networks in order to access the datacenters from a central office 120. NMSs are typically placed at a data center for efficiency.

A traditional NMS systems use a “search light” monitoring method that scans a network from a single or limited perspective on the network. As shown in FIG. 1, sweeps of the critical application 110 that is residing at the datacenter 105 are done from the point-of-view of the NMS 115. Since the NMS is situated at the datacenter measurements of response time of the network are measured from the data center NMS point-of-view and would not detect slow downs experienced by clients.

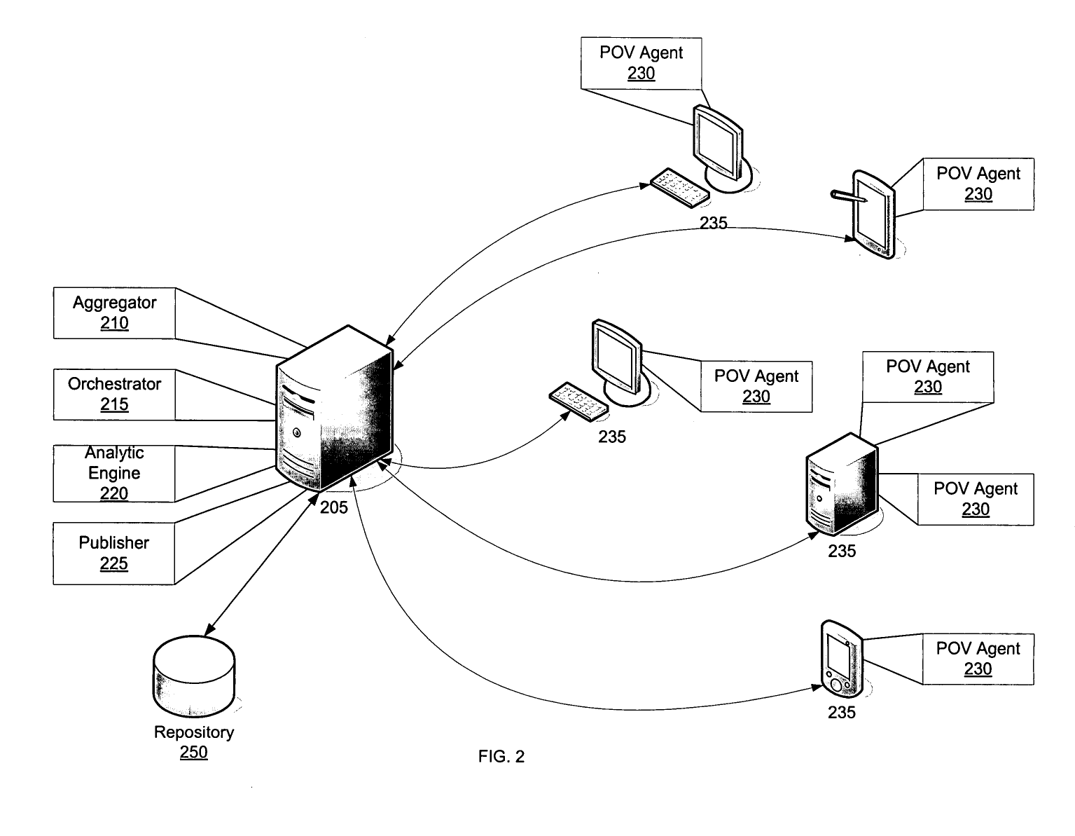

The present invention is initially described in relation to FIG. 2. In contrast to the prior art NMSs as described above, FIG. 2 illustrates that the POV Methodology of the present invention places monitoring agents on the client systems 235 themselves, thus ensuring a true perspective monitoring. As shown in FIG. 2, a preferred exemplary embodiment of the present invention comprises a network having a central sever system 205. The central server comprises a plurality of executable software components software elements of that are executable in the main memory, but as persons skilled in the art will understand, the software elements may not in actuality reside in their entirety in the main memory.

The software components located at the central server 205 comprise a connection and data aggregator 210, a job and system configuration orchestrator 215, an analytic engine 220, a publisher 235 and a data repository 250. The central server system 205 is in communication with a plurality of end-point client systems 235. Residing in each client system 235 is a POV agent 230.

As shown in FIG. 2, POV agents 230 analyze a network from the standpoint of the end points 235, the definitive benchmark and point of reference for measuring network health. POV agents 230 can more accurately examine and quantify the availability and quality of an entire business infrastructure. Further, the end points 235 typically directly affect the end-user experience, thus issues relating to the end points 235 system's runtime environment, network connectivity, and usage directly affect end-users. As an NMS product improvement, POV agents 230 are designed to work with, and not replace existing NMS products. The architecture of the present invention allows for various common connectors that expose results from the POV agents to a NMS.

The POV network management methodology of the present invention comprises an architectural and algorithmic component. The architectural components consist of: POV agents, a connection and data aggregator, the data repository, a job and configuration orchestrator, an analytic engine, and an alert notification engine.

The algorithmic components consist of algorithms for: the automated determination of a baseline in a group of homogeneous client systems, comparing client systems to the baseline to determine if they are deviant, and processing and detection of commonalities between client systems in a homogeneous groups and cross-correlating the results between deviant and non-deviant systems for the purpose of root cause identification.

As mentioned above, traditional NMS systems use a “search light” monitoring method that scans from a network from a single or limited perspective on the network, wherein sweeps of the infrastructure are done from the point-of-view of the NMS. Within aspects of the present invention, network scans are performed from multiple end-point client systems 235 from both the client and real-user perspective. Monitored information collected in this manner can be correlated to provide better root cause analysis as well as a true indication of how clients are affected.

Various types of perspective monitoring can be accomplished using a POV system as presently described within aspects of the present invention. The monitoring procedures comprising:

1. Protocol Layer Monitoring—Establishes a persistent connection to the Aggregator and detects network outages when the connection is broken. A small timing packet is sent periodically to ensure data can flow across the established socket. This type of monitoring is referred to in U.S. Provisional Patent Application Ser. No. 60/638,863 titled “A METHODOLOGY FOR THE DETERMINATION OF NETWORK AND APPLICATION OUTAGES BASED ON PERSISTENT CONNECTIONS,” the disclosure of which is incorporated herein by reference in its entirety.

2. Trace Route—probably the one of the simplest but extremely useful measures of network performance and issues. Correlating trace route data between many end-points provides early detection and bottlenecks by finding a commonality of broken or slow end-points.

3. Web Transaction Monitoring (Synthetic Transaction)—Capable of monitoring simple URLs, e-commerce systems, intranet systems, web services, and web applications.

4. Citrix/ICA (Synthetic Transaction)—Monitors the availability and response time to Citrix servers.

5. Reflections Monitor (Synthetic Transaction)—Monitors the availability and response time to X windows servers and legacy terminals (WRQ).

6. Network Bandwidth Flow Rate Monitor—Unlike trace route monitor, this monitor will read the number of inbound and outbound packets from the network performance counter and measure them over time to get a bandwidth measure. The monitor will be smart enough to know when you are actively moving information and return a result such as 52 Kbytes per second. A threshold can be set on what an acceptable rate is. A low bandwidth rate may lead to user-perception of slowness. This measured value can be seen when transferring a file using Internet Explorer. One technique for testing this rate may be simply to transfer a small file to and from other end-points.

Due to the fact that networks may be disparate and located a great distance both physically and topographically apart, aspects of the present invention provide a lightweight proxy through which POV Agents can tunnel to central Aggregator 210 and Orchestrator 215 data clusters. Within aspects of the present invention POV proxies act as small tunneling relay that can be used to relay messages over a known port to the central cluster. They are designed to make configuration of the firewall rules for deployment easier using such techniques as HTTP-Tunneling over port 80 which is normally open (at least outbound). Further, since one of the issues from the client perspective is that the network can be down at a central location, the use of POV proxies can alleviate that point of failure. A POV Proxy can be used to relay information and further to use other means of notification.

Alternatively, POV agents 230 can use a one-way communication methodology, allowing them to directly connect to Aggregators 210 alleviating the need for a POV proxy. This methodology is employed in environments where employing a proxy may not be suitable or possible, such as behind non-controlled routers found in home office environments and other similarly design environments. The POV agents 230 in these cases create an outbound connection to the central aggregator 210 and orchestrator 215 requesting instructions and sending information in a pull oriented fashion.

The POV Architecture forms the basis for various systems that can be tailored for specific monitoring purposes. The architecture describes a logical set of components and interaction, not the actual physical implementation. For example, in practice, the repository 250 and orchestrator 215 may be combined into one software server component even though the logical purpose of each is distinct. A software POV agent 230 is deployed at some or all end-point client systems 235 specifically for the purpose of observing the function of the client system 235 from both a transactional (external) and environmental perspective (the static and runtime environment of the client system 235) from the client system's point-of-view.

Each agent connects to a server (aggregator 210) that is specifically designed to maintain connections and aggregate information. The functions of many agents are coordinated by another logical server (orchestrator 215) that is capable of coordinating the activities of a class of client systems 235 as a whole for the purpose of achieving group goals in an environment that is transient (no guarantee of the availability of any singular agent to perform a task). Additional aspects of the present invention provide for an interface to a persistent storage (database or otherwise) (repository 250). An engine for the purpose of performing cross-system analytics (analytic engine 220) is also provided, and thereafter a logical component makes information available to external systems (publisher 225),

The uniqueness of the POV architecture of the preset invention is specifically embodied within the design of the POV software agents 230, which takes into account the transactional (observed or synthetic) and environmental (OS, hardware, software, usage pattern) to better determine root cause. The design of the POV software agents 230 is to run on production systems and not test systems, taking into account the necessity for minimal impact, allowing the software agents to be run from the point-of-view of the actual client systems and not from test systems.

The coordination of POV agents 230 to achieve a task in an environment that is transient (e.g., where there is no guarantee that any particular POV agent 230 can perform a task), such that tasks can be reallocated if not performed within a given time frame. This aspect grants the ability to perform massively distributed monitoring tasks using all agent resources and not limited to configuring purely a single agent. Information across POV agents 230 is aggregated together and looked at collectively rather than as one element, such that results from external transactional monitoring can be verified by other POV agents 230, as well as, combining information from logical groups. Further, the analysis of information across homogeneous groups of client systems 235 for the purpose of determining a group norm, deviations from the norm, as well as detecting commonalities within a group of deviant or non-deviant machines or cross-comparing the commonalities between both deviant and non-deviant is provide within aspects of the present invention.

The POV Architecture provides a means by which various algorithms for automated creation of groups from both environmental and runtime statistics, along with user-defined criteria, can be employed to programmatic cluster client systems 235. The default criteria employed in the initial embodiment defines homogeneous systems as computer systems where: 1) the type and major version of an operating system (OS) is identical, 2) the processing hardware platform which includes the processor type and speed along with the amount of physical memory, and 3) optionally, the primary use of the system as manually entered by the user of the POV client system 235.

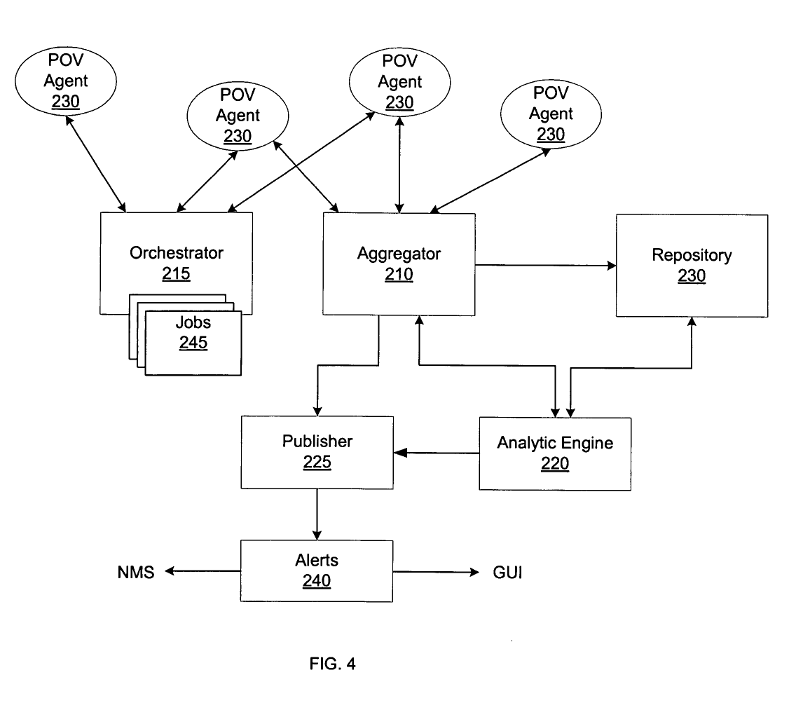

As illustrated within FIGS. 2 and 4, within aspects of the present invention the major components are distributed POV agents 230—software component installed on client systems 235, which perform tasks from the client system's 235 point-of-view; centralized orchestrators 215—providing control the monitoring responsibilities of several POV agents and coordinates communications among them; centralized aggregators 210—providing the collection of information from several POV agents 230 and the correlation of the information; centralized repository 250—for the control of access to a persistent information store; a centralized analytic engine 220—provided with the capability to compare a massive number of variables for the purpose of determine baselines, finding deviant systems, and determination of commonalities between deviants systems, as well as differences from non-deviant systems; a centralized publisher 225—publishes information from a POV system for consumption by external systems through common interfaces. Additionally, each centralized component has an exposed interface for the building of user interfaces.

Within embodiments of the present invention, distributed POV agents 230 request jobs 245 from the orchestrator 215 when they are free to do work. The orchestrator 215 functions to allocate jobs and times to complete the jobs. Once assigned a job, a POV agent 230 attempts to perform the job. In the event that the job is not completed in the allocated time, the job is reassigned to another POV agent 230, thus removing the possibility of transience.

The failure events information gathered by POV agents 230 are reported to the aggregator 210. The information collected by the aggregator 210 and sends it to the repository 250. Any commonalties between the information gathered by the POV agents 230 is thereafter reported them to the publisher 225 to package and send to a respective NMS or Management Console

Specifically, aggregators 210 are able to recognize network problems and determine if other POV agents 230 have experienced similar or identical issues. In the event that differing POV agents 230 have reported similar information, the aggregator 210 utilizes the analytic engine 220 to compare the information and find the commonalities contained therein. Additionally, the publisher 225 publishes an alert with the additional information on the potential root cause and commonalities.

If other client systems 235 are not having the same issue, then the aggregator 210 sends a request to the orchestrator 215 to ask other POV agents 230 to check for the same issue. When the results are returned, if only a single POV agent 230 is reported as being affected, all debug information and information stating that other POV agents 230 checked for the issue and did not find the problem as well is aggregated and sent as an alert.

As stated above, within aspects of the present invention the basic assumption of POV agent 230 is that no POV agent 230 is guaranteed to be accessible at any given time. Traditional NMS systems rely on their components to be available, whereas POV architecture assumes the opposite. The present invention is self-realigning, meaning that the system is configured to tap into a network of POV agents 230 in order to perform tasks, and has the capability to “wake” dormant agents as needed to complete specified job tasks. This particular aspect illustrates the multi-point event aggregation capabilities of the present invention. Multi-point aggregation involves correlating the same event over many devices whereas event correlation is the relating of multiple individual events.

Because a POV system can aggregate the same event over multiple end-points, it can detect commonalities between the end-point client systems 235, and present that information in a number of different views for better root cause detection. This is especially true when the various end-point client systems 235 belong to homogeneous groups. Further, POV agents 230 can specifically be coordinated to assist in monitoring efforts across differing client systems 235. Unlike traditional NMS systems with agents and probes, a POV system can coordinate the efforts of the POV agents 230 in order to provide the best possible detection, verification and diagnosis of an issue.

Due to the described functional aspects of a POV system, the POV system can provide a more accurate assessment of impact from the client perspective. Since POV is best used in client system environments where client systems typically in like purposed, similar hardware and software environments, a determination of a baseline norm can be made statistically and anomalous systems can be detected. Additionally, instead of providing a simple alarm event, POV is designed to provide rich alarms that include more detailed, critical data along with diagnostic help information.

Many NMSs provide a simplistic “threshold-crossed, then alarm” based mechanism. This yields numerous false alarms due to momentary spikes or anomalous conditions on the network. Traditional NMSs alleviate false-positives by incorporating three distinct intelligent threshold mechanisms based on number of events, duration, and criticality.

In contrast, the POV agents 230 of the present invention add an extra dimension to intelligent monitoring by monitoring “impact” of the alarm across the end points. This last dimension, based on the number of clients affected is unique to monitoring today. It has the potential to increase the productivity of the IT department and the business itself by prioritizing work based on how many and which people are affected by the network trouble.

The impact determination mechanism works using the following heuristic:

If the issue exists on one system only, then there is a high probability the issue is related to the system individually and not the network or server application. Internal diagnostics and health checking may best determine the root cause.
If the issue exists on all systems in a like group, the issue is most likely related to the network or server-side application. Additional diagnostic information such as network and server-side checks can assist in further narrowing the issue to either the network or server-side application.
If the issue exists on some but not all systems in a like group, the issue is most likely on the deviant systems and comparing the deviant systems to non-deviants systems may be the best indicator of the issue.
   Applying impact to the typically alarm/notification mechanism, allows IT organizations to better direct resources, since issues related to the client systems, network and server-side applications are typically handled in organizations by different human resources.

As shown in FIGS. 2 and 4, an orchestrator 215 work from a global job list 245. This listing contains a list of all jobs to perform by distinct groupings of client systems 235 in the entire network 200. The orchestrator 215, working with a network topology and group specification, resolve what jobs to assign to which POV agents 230. The orchestrator 215 attempts to assign the jobs and then monitors to ensure that the jobs are being completed. If they are not completed within a desired timeframe, the job is reassigned.

Within aspects of the present invention, jobs are assigned in a pull-model. A POV agent 230 when free notifies the orchestrator 215 it has spare cycles and how many jobs it can handle. Thereafter, the orchestrator 215 determines the appropriate amount of jobs to assign to the POV agent 230. As long as a POV agent 230 can complete the job, it will keep the job and report status completes to the orchestrator 215. At this point, the POV agent 230 and the orchestrator 215 will not communicate (except for the job done reports) unless the orchestrator 215 wishes to reassign the job or cancel the job, this aspect greatly reduces the communication between the components.

Aggregators 210 are the components of a POV system that are responsible for receiving alarm notifications and data from multiple POV agents 230, in addition to working in conjunction with the analytic engine 220 to find commonalities between reported information. Aggregators 210 further make requests of the orchestrators 215 for additional information from either the same alarming POV agent 230 or independent verification of the information from other POV agents 230 in the same group.

One of the greatest concerns facing the POV system is that there might be a flood of data coming to an aggregator 210. In the more state of the art systems, there is a limiting factor due to the ability to write to a persistent store. The POV Architecture specifies that the task of aggregation be separated from the task of data storage. Therefore, if we throttle the agent communication and force aggregation so that the aggregator 210 only receives alarm events from the POV agent 230 along with collected data, the number of envelopes (comprised of several packets) sent from any POV agent 230 to an aggregator 210 should be minimal.

The goal or any implementation of the POV architecture would be to achieve a minimal ratio 1 aggregator per 1,000 nodes. Ideal would be 1 aggregator to 5,000 nodes. The 1:1000 ratio has already been proven possibly by separating the role of persistent storage from the aggregator 210.

The aggregator 210, in conjunction with the other components, is responsible for aggregating information and creating an “enriched” alarm. An enriched alarm contains alarm information, impact, verification, and diagnostic information.

To create an enriched alarm:

the aggregator 210 receives an alarm event from a POV agent 230;
the aggregator 210 determines whether other POV agents 230 have the same issue;
the aggregator 210 makes a request to the orchestrator 215 to ask other POV agents 230 to verify the issue;
all events of the same class are consolidated; and
the analytic engine sorts the environment data (system, network, and alarm data) to find commonalities.
   Thereafter, commonalities, impact numbers and all diagnostic bits of information and blame are written into an enriched alarm.

The foundation of the POV architecture is the POV agent 230 (FIGS. 2, 4 and 5). A typical installation would attempt to saturate a network with POV agents 230 that work independently and can also be called upon and directed, as needed. A POV agent 230 is installed at a client end-point. POV agents 230 are configured to receive commands from a centralized command structure, which coordinates its activities with the other POV agents 230. A POV agent 230 periodically requests configuration updates and additional tasks to perform from the centralized server 205. When the server 205 is not available, the POV agent 230 is able to operate in a self-sufficient mode.

Specifically, each POV agent 230 monitors critical services for availability and response time using smart (complex monitoring with decision branching) and dumb monitors. The smart and dumb monitors comprising, but not limited to: network connection availability (dumb); port connect tests (dumb); ping (dumb); database connection test (dumb); URL connection test (dumb); Web Transaction Monitoring (smart); business services response time and codes (smart); active directory checks (smart); email testing (smart).

The POV agent 230 also performs network layer checks, including but not limited to Gateways, DNS and WINS. Internal health checks performed by a POV agent 230 include but are not limited to: changes in hardware components; changes in software components; runtime Environment and system configuration. Once a potential problem is detected, internal health checks are done to verify the trouble is not on the local system but rather, is external. These checks are considered diagnostic information and used by the centralized component of the POV Architecture for blame assessment and production of enriched alarms.

Data transmitted from POV agents 230 is stored on each transient system in flat files and synchronized with a central repository during background operation. Information can be transferred for reporting and viewing purposes on-demand. Periodically, summarized data is transmitted to the centralized components of the POV system.

POV agents 230 continually monitor the local system, but only monitor external devices when the agent detects the CPU and I/O of the host desktop is not being heavily utilized, thereby harnessing the idle cycles. To reduce the flow of data, only events and alerts are typically sent out from the local transient system. Summarized data is sent periodically. Detailed information can be requested on demand by other POV system components.

While traditional agents primarily monitor the component they are installed on, POV agents 230 also interrogate and inspect aspects of the network apart from their endpoint. Primarily, POV agents 230 monitor the resources of the system on which they are installed and are designed to operate efficiently as a secondary and less important system task. Thus, a significant amount of knowledge and capability is placed into a POV agent 230 including detection, diagnosis, and resolution heuristics.

Specifically, within aspects of the present invention, POV agents 230 have local stores 525 of information designed to prevent over burdening the network with monitoring data on a regular and routine basis. Since POV agents 230 can store information locally, they can compress and send back collected data using batch updates rather than continuous feeds. In addition, since data is accumulated, the potential exists for high-level compression. A batch update mechanism allows for synchronization with reporting systems and transporting large amount of detailed data without burdening the network or deteriorating the client experience. A traditional POV agent 230 placed on a client system's 235 system sending back data and processing continuously could degrade or contribute to the degradation of performance.

Within additional aspects of the present invention, POV agents 230 can hibernate and only use minimal resources on a system when needed and directed. POV agents are designed with specific heuristic knowledge when tackling monitoring issues. The purpose of this intelligence is to move “blame” assessment capabilities into the POV agent 230 itself. When the POV agent 230 detects an issue, it can compare empirical data regarding the local system to the network's status from its perspective to quickly isolate the issue to the client, network or application server.

An example would be when monitoring a web application server, a POV agent 230 detects that the response time to the server is too slow. It then gathers local system information to determine the following:
Is the local CPU overloaded?
Is the disk swapping?
How is memory usage?
Is virtual memory being used?
Is the user performing a file operation that may be impacting the bus?
If the CPU is overloaded, what application is using the most processing power?
Is the network connecting?
Are there any slowdowns in the network (performing a traceroute)?
Are there errors on the network card?
Is the URL being retrieved using DNS? If so, what is the DNS resolution time?
How many packets per second are coming to this network card? Is it overloaded?
   By answering these questions before sending the alarm event, the POV Agent can determine (or help establish) if the problem is located in the local System, network, or in the monitored application.

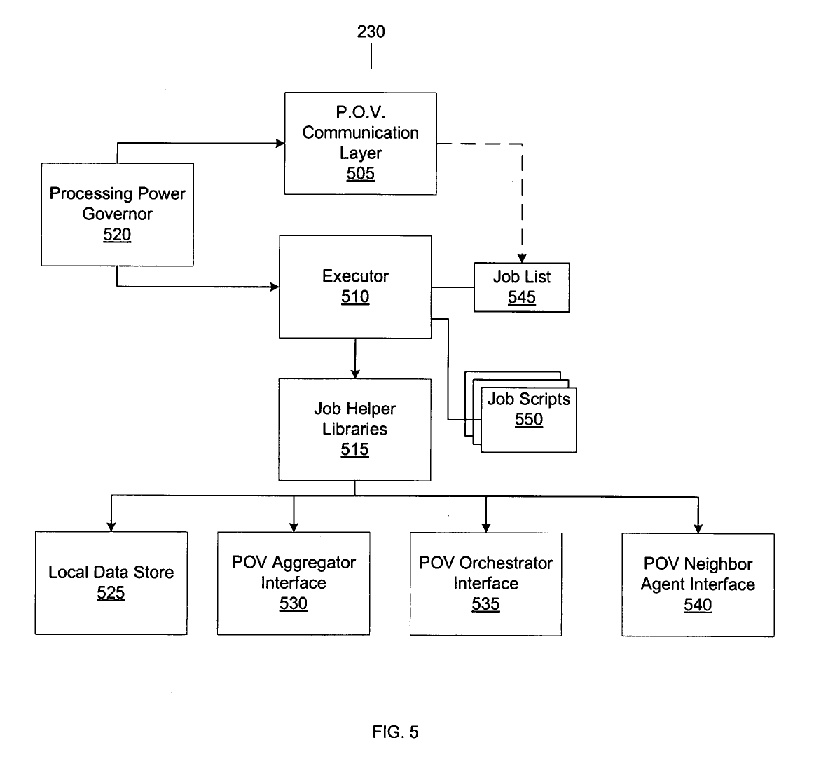

FIG. 5 shows a preferred architecture for a POV agent 230. Each POV agent 230 comprises a POV communication layer that is listens on a POV agent port and is in communication with a processing power governor 520. FIG. 5 shows a preferred architecture for a POV agent 230. Each POV agent 230 comprises a POV communication layer that is listens on a POV agent port and is in communication with a processing power governor 520. The POV communication layer 505 authenticates, encrypts and transfers files between the POV agent and the central server 205. The processing power governor is entrusted with the responsibility of controlling the POV agents 230 processing power.

A job list 545 comprised within an executor 510 is supplemented with current job assignments via the POV communication layer 505. Further, job script 550 is generated within the executor 510, wherein the job script is dynamically loaded and statically linked with the POV agent 550. A job helper library 515 is implemented in order to provide standardized helper functions for the job scripts 550. Further, the POV agent 230 comprises a local data store 525 in addition to an aggregator interface 530, an orchestrator interface 535, and a neighboring POV agent interface 540.

POV Analytic Engine Algorithms

A very important aspect of the present invention is the capability to analysis information across homogeneous groupings of client systems 235 for the purpose of determining a group norm, deviations from the norm, as well as detecting commonalities within a group of deviant or non-deviant client systems 235 or cross-comparing the commonalities between both deviant and non-deviant client systems 235.

The underlying assumption of the algorithms utilized within the analytic engine 220 is that they are applicable when the group of client systems 235 are relatively homogeneous, comprise similar hardware, software, and are liked purposed. The systems do not need to be identical, as the purpose of these algorithms is to determine what anomalous factors may contribute to variations in behavior between what should be identical systems. Variations are natural; however, deviations in behavior may be seen as undesirable in a live environment with business critical applications.

The algorithms used within aspects of the present invention work on the premise that client systems in a homogenous group should behave similarly. The algorithms represent an embodiment of a number of variations, which rely on the premise that a statistical baseline can be derived in a network-monitoring environment when the client systems are homogeneous in hardware, software, and use. Through use of the application of this premise, deviant systems can be identified and advanced diagnostics can be determined through group comparison algorithms for purpose of commonality detection and showing differences between deviant and non-deviant groups of systems in the homogeneous group. Thus, while the present invention describes the algorithms listed below in detail, it contends that a class of similar algorithms and variations can be derived based on taking into account that a true statistical baseline can exist for a set of homogeneous client computer systems.

Traditionally, network systems are monitored through a set of thresholds and violations of those thresholds create failure events. These thresholds are typically set by humans or through heuristics based on what is considered normal. Due to the fact that today's environments may encompass thousands of client systems, each of which containing hundreds and thousands of individual metrics, such a determination without a programmatic means is practically impossible. Further, setting thresholds, even in an automated fashion does not account for overall group movements and variations. Such variations can be easily seen in e-commerce systems that peak at specific times in the day when the number of shoppers are highest. The norm for a group of such systems will fluctuate during the day. Thus, the definition and determination of baseline and deviant systems should fluctuate as well.

The following algorithms operate on the assumptions that: 1) a statistical norm exists for a group of homogeneous (like configured and purposed) systems, 2) the norm can be continuously recomputed, 3) deviations from the norm is typically undesirable and those systems should be identified, and 4) further identification of what variations exists between groups of deviant and non-deviant systems can prove to be extremely useful in determining why systems are deviant.

Algorithm 1: Baseline Determination/Finding the Norm

Collected data from the POV Agent can be divided into 2 classes:

a. Environmental—relatively static data that describes the physical state of the system. This includes Operating System, hardware specification, other installed application, and configuration.
b. Runtime—data, which represents the current state of the client system and is volatile, these are normally in the form of metrics; however, may include lists of running processes as well as other non-numeric data.
   Since the collected data is divided into two parts, the baseline is defined along two dimensions as well.
   Environment Baseline Algorithm
1. Create a hash table (HT-ENV-1) where the key is comprised of a hash of the name of the environmental attribute, such as “Operating System”, with its value, such as “Windows 2000”. The value will be the number of client systems in the group that share the attribute.
2. For each client system,
   a. Creating a key for the environmental attribute.
   b. Get the value/number of occurrences from HT-ENV-1.
   c. Increment that value by 1 and add back into the HT-ENV-1.
3. Create a Baseline Table (BT-ENV-1) with the following columns
   a. Attribute Name
   b. Attribute Value
   c. Weight=% of client systems that share the attribute value (range: 0-1)
   d. Adjusted Weight—a dynamically adjusted weighting value (default to 1).
      Numeric Runtime Baseline Algorithm
1. Create a hash table (HT-RT-1) where the key is the name of a numerical metric, such as “% CPU Utilization” and the value is a structure which holds: the minimum value (min), maximum value (max), average (average), and standard deviation (stddev). The values in the structure may differ in implementation for optimization reasons; for instance, average can be stored as a total and count and derived on demand. The same technique may be employed for computation of standard deviation.
2. For each client system,
   a. For each numerical metric (given a fixed window, such as past 24 hours), update the corresponding entry for the metric in HT-RT-1.
3. Let BT-RT-1 define the numeric runtime baseline and contain the values from HT-RT-1.

At this point, HT-RT-1 should be an aggregate across all systems of the all collected numeric metrics.

Non-Numeric Runtime Baseline Algorithm

1. Create a hash table (HT-RT-2) where the key is a simple hash of the name of the metric with the metric value. The value is a count of the # of systems that contain that metric.
2. For each client system,
   a. Creating a key for the non-numeric runtime attribute.
   b. Get the value/number of occurrences from HT-RT-2.
   c. Increment that value by 1 and add back into the HT-RT-2.
3. Create a Baseline Table (BT-RT-2) with the following columns
   a. Attribute Name
   b. Attribute Value
   c. Weight=% of client systems that share the attribute value (range: 0-1)
   d. Adjusted Weight—a dynamically adjusted weighting value (default to 1).
      Algorithm 2: Detection of Deviant Systems

Deviant systems are defined as systems where the deviation from the norm violates the algorithmic formula given below:

For each client system, given all the baseline times derived in Algorithm 1,

Determining the Environmental Variance

1. Let ENVIRONMENTAL_VARIANCE=0;
2. For each environmental variable for the client system,
   a. Get the key for the variable as defined in BT-ENV-1
   b. If the key was found in BT-ENV-1,
      c. Get the value based on the key. The value will be a structure
         i. Attribute Name
         ii. Attribute Value
         iii. Weight=% of client systems that share the attribute value (range: 0-1)
         iv. Adjusted Weight—a dynamically adjusted weighting value (default to 1).
      d. Get an attribute variance value (ATTR_VAR) using the formula:
         ATTR_{—}VAR=1−(Weight*Adjusted Weight)
   e. If the key was not found in BT-ENV-1,
      i. Let ATTR_VAR=1
   f. Increment ENVIRONMENTAL_VARIANCE by ATTR_VAR
3. For each environmental variable in BT-ENV-1 as a key that is not found in the list of environmental variables for the client system,
   a. Get the value for the variable from BT-ENV-1
   b. Let the ATTR_VAR=Weight*Adjusted Weight
   c. Increment the ENVIRONMENTAL_VARIANCE by ATTR_VAR
      Determining the Non-Numeric Runtime Variance
1. Let NONNUMERIC_RUNTIME_VARIANCE=0;
2. For each environmental variable for the client system,
   a. Get the key for the variable as defined in BT-RT-2
   b. If the key was found in BT-RT-2,
   c. Get the value based on the key. The value will be a structure
      i. Attribute Name
      ii. Attribute Value
      iii. Weight=% of client systems that share the attribute value (range: 0-1)
      iv. Adjusted Weight—a dynamically adjusted weighting value (default to 1).
   d. Get an attribute variance value (ATTR_VAR) using the formula:
      ATTR_{—}VAR=1−(Weight*Adjusted Weight)
   e. If the key was not found in BT-RT-2,
      i. Let ATTR_VAR=1
   f. Increment NONNUMERIC_RUNTIME_VARIANCE by ATTR_VAR
3. For each environmental variable in BT-RT-2 as a key that is not found in the list of environmental variables for the client system,
   a. Get the value for the variable from BT-RT-2
   b. Let the ATTR_VAR=Weight*Adjusted Weight
4. Increment the NONNUMERIC_RUNTIME_VARIANCE by ATTR_VAR
Store the ENVIRONMENTAL_VARIANCE and
NONNUMERIC_RUNTIME_VARIANCE by each client.
   Converting the Variances into Statistical Constituents
   Compute the average, minimum, maximum, and standard deviation across all client systems for the ENVIRONMENTAL_VARIANCE and

NONNUMERIC_RUNTIME_VARIANCES. The values should be recorded as:
Avg(ENVIRONMENTAL_VARIANCE)
Min(ENVIRONMENTAL_VARIANCE)
Max(ENVIRONMENTAL_VARIANCE)
StdDev(ENVIRONMENTAL_VARIANCE)
Avg(NONNUMERIC_RUNTIME_VARIANCE)
Min(NONNUMERIC_RUNTIME_VARIANCE)
Max(NONNUMERIC_RUNTIME_VARIANCE)
StdDev(NONNUMERIC_RUNTIME_VARIANCE)
   Determining is any given Client System is Environmentally Deviant
   A client system is said to be “Environmentally Deviant” if a client's ENVIRONMENTAL_VARIANCE is
greater than
   Avg(ENVIRONMENTAL_VARIANCE)+
   1*StdDev(ENVIRONMENTAL_VARIANCE)
      or
less than
   Avg(ENVIRONMENTAL_VARIANCE)−
   1*StdDev(ENVIRONMENTAL_VARIACE)
      Determining is any given Client System is Non-Numerically Runtime Deviant

A client system is said to be “Non-Numerically Runtime Deviant” if a client's NONNUMERIC_RUNTIME_VARIANCE is
greater than
   Avg(NONNUMERIC_RUNTIME_VARIANCE)+
   1*StdDev(NONNUMERIC_RUNTIME_VARIANCE)
      or
less than
   Avg(NONNUMERIC_RUNTIME_VARIANCE)−
   1*StdDev(NONNUMERIC_RUNTIME_VARIANCE)
      Determining is any Given Client System is Numerically Runtime Deviant

A client system is said to be “Numerically Runtime Deviant” if for each numeric attributed of the client, any attribute is considered numerically deviant.

An attribute is numerically deviant 1F
Avg(client attrib.)+StdDev(client attrib.)>Avg(group attrib.)+StdDev(group attrib.)
-or-
Avg(client attrib.)−StdDev(client attrib.)<Avg(group attrib.)−StdDev(group attrib.)
   Where,
   client attrib. is an individual client attribute
   group attrib. values are retrieved from the baseline table BT-RT-1.
      Overall Designation of a System as Deviant

A system is considered deviant if it is Environmentally, Numerically or Non-Numerically Deviant. Users may place different weightings on the value of being deviant on any particular dimension above.

Algorithm 3: Determination of Commonalities

To determine commonalities in a group, a baseline calculation using the Algorithm 1 is utilized to derive BT-ENV-1 and BT-RT-2 for the group by applying the algorithm only over client systems in the group. This algorithm applies to non-numeric values, both runtime and environmental.

For each baseline, all attributes are sorted by weight and a histogram is made in reversed weighted order creating HIST-ENV-1 and HIST-RT-2. The first element of each histogram will be the attribute that occurs in the larger percentage of systems. An artificial cut-off (defaulting to 95%) can be made to find values that common to at least 95% of the client systems in the grouping. This group of values is referred to as the set of commonalities. The cut off threshold value may be changed for analysis purpose of loosening constraints to see other commonalities.

Deriving Differences between Two Set of Commonalities

The most useful application of the above algorithms lies in conjunction is the determination of differences between two sets of commonalities.

To find the difference between two sets of commonalities:

1. First build a set of commonalities each group (named Group A and Group B).
2. Find all elements not found in Group A not found in Group B, these values form a new histogram for attributes of A not in B, referred to as HIST-A-NOT-B.
3. Find all elements not found in Group B not found in Group A, these values form a new histogram for attributes of B not in A, referred to as HIST-B-NOT-A.

By using Algorithm 2 to find deviant systems in conjunction with the ability to find the difference histograms, POV is able to determine:
1. What attributes does the class of deviant client systems have in common?
2. What attributes does the class of non-deviant client systems in the same homogeneous group share that are not shared by the deviant systems.

The above two determinations provide extremely valuable insight for purposes of troubleshooting and root cause determination. The above process is typically engage by humans involved in troubleshooting a variety issues; however, in Information Technology, the number of variables becomes so large that without an algorithmic approach that can be coded into a computer system, it would be virtually impossible to find the commonalities in a methodical manner.

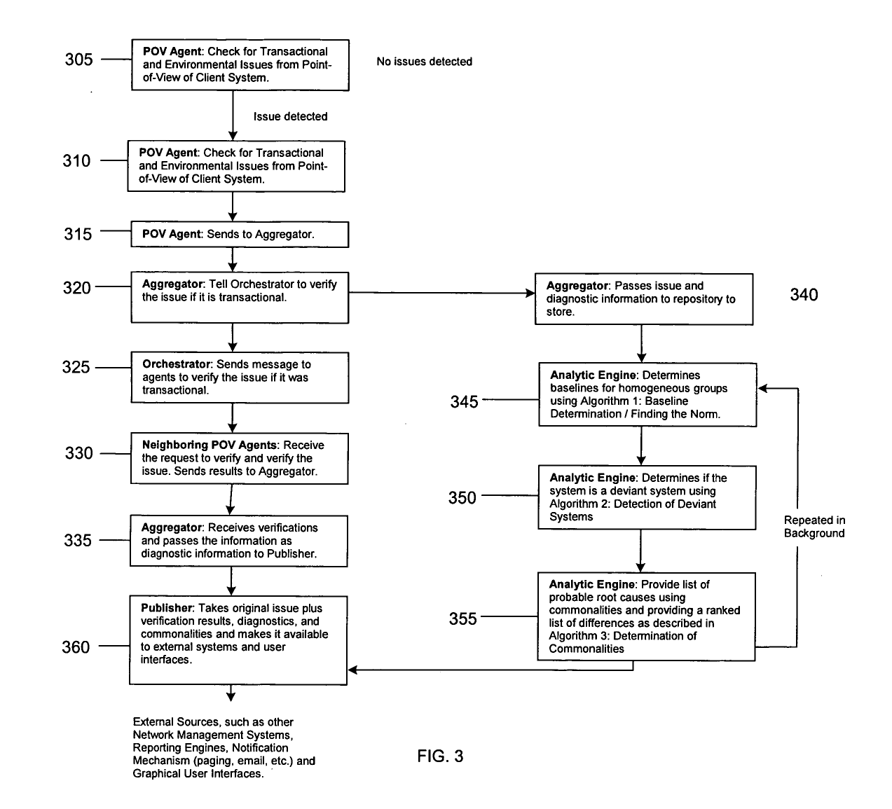

FIG. 3 is a flow diagram that illustrates a preferred function of the client-based monitoring aspects of the present invention. At step 305 the POV agent 230 checks for transactional and environmental issues from the point-of-view of a client system 235. If no issues are detected, the POV agent will repeat the function. If an issue is detected, the POV agent 230 will proceed to step 310. At step 310, the POV agent 230 performs real-time diagnostics on the client system 235, recording both runtime and environmental state information in regard to the client system 235. At step 315 the POV agent sends the acquired client system 235 information to the aggregator 210.

At step 320 the aggregator 210 tells the orchestrator 215 to verify the issue if it the issues are transactional. Concurrently, the aggregator 210 passes the issue and diagnostic information to the repository 250 to store at step 340.

At step 335, the Orchestrator 215 sends a message to the POV agents 230 to verify the issue if it was transactional. Next, at step 330, neighboring POV agents 230 receive the request to verify and verify the issue and send the results of the verification operation to the aggregator 210. At step 335, the aggregator 210 receives the verifications from the neighboring POV agents 230, and passes the information as diagnostic information to publisher 225.

Further, at step 345, the analytic engine 220 determines baselines for homogeneous groups of POV agents 230 using Algorithm 1: Baseline Determination/Finding the Norm. Next, at step 350, the analytic engine 220 determines if the client system 235 is a deviant system using Algorithm 2: Detection of Deviant Systems. At step 355, the analytic engine 220 provides a list of probable root causes using commonalities and providing a ranked list of differences as described in Algorithm 3: Determination of Commonalities and sends these findings to the publisher. At step 360, the publisher 225 takes original issue plus verification results, diagnostics, and commonalities and makes it available to external systems and user interfaces via external sources, such as other Network Management Systems, Reporting Engines, Notification Mechanism (paging, email, etc.) and Graphical User Interfaces.

Therefore, it will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed:

1. A system for the client-based perspective monitoring and diagnosis of issues relating to a client system, the system comprising:
a central server, wherein a point-of-view agent aggregator resides at the central server, the point-of-view agent aggregator maintains communication and aggregates data that is received from point-of-view agents;
at least one client system, wherein the client system is in communication with the central server;
a plurality of point-of-view agents, wherein at least one agent resides within at least one client system and is in communication with the central server, the point-of-view agent being configured to monitor the client system's operations from the client system's perspective and transmit the acquired monitored data to the central server and a point-of-view agent coordinator; and
a point-of-view agent coordinator, either residing locally at the central server or at a remote server that is in communication with the central server and the plurality of point-of-view agents, wherein the point-of-view agent coordinator transmits control commands to the plurality of point-of-view agents.

2. The system of claim 1, further comprising a repository residing at the central server, wherein the repository is in communication with the point-of-view aggregator and an analytical engine, data transmitted from the plurality of point-of-view agents to the point-of-view aggregator being stored within the repository.

3. The system of claim 2, further comprising an analytical engine residing at the central server, wherein the analytical engine is in communication with the point-of-view aggregator, wherein the analytical engine assigns respective client systems to groups based upon runtime, environmental, and use criteria.

4. The system of claim 3, wherein the analytical engine uses the data acquired from the point-of-view agents to determine client system baselines, identify deviant client systems, the determination of commonalities between deviant client systems, and the determination of the commonalities between deviant client systems and non-deviant client systems.

5. The system of claim 4, wherein the analytical engine reports its findings to a publisher, wherein the publisher packages and transmits the findings to a network management system.

6. The system of claim 5, wherein the point-of-view-agent coordinator transmits a command to a specific point-of-view agent to perform a predetermined client system monitoring function.

7. The system of claim 6, wherein upon the completion of the predetermined client system monitoring function, the point-of-view agent will transmit a performance-completed message to the point-of-view coordinator.

8. The system of claim 7, wherein if the point-of-view agent determines that the predetermined client system monitoring function has not been completed within a specified time, the point-of-view agent will reassign the predetermined client system monitoring function to another point-of-view agent to complete.

9. The system of claim 8, wherein upon the detection of a deviant client system an alarm function is initiated.

10. A method for the client-based perspective monitoring and diagnosis of issues relating to a client system, the method comprising the steps of:
distributing a plurality of point-of-view agents on at least one client system, wherein the point-of-view agents monitor predetermined operations of the client system;
coordinating the collection of the client system monitoring data acquired by the point-of-view agents;
confirming the validity of the acquired client system data;
assigning respective client systems to groups based upon runtime, environmental, and use criteria;
analyzing the acquired data in order to ascertain any commonalities that may exist between the data of differing client systems and differing groupings of client systems;
identifying a deviant client system in the event that the acquired data in regard to the client system determines that the client system behavior is deviant; and
initiating an alarm function that identifies the deviant client system.

11. The method of claim 10, wherein the step of coordinating the collection of client system monitoring data further comprises the step of distributing specific monitoring functions to individual point-of-view agents.

12. The method of claim 11, wherein the step of coordinating the collection of client system monitoring data further comprises the step of verifying the completion the individual point-of-view agents specific monitoring functions.

13. The method of claim 12, wherein if it is determined that a point-of-view agent has not completed a specific monitoring function, the monitoring function is assigned to a different point-of-view agent.

14. The method of claim 10, wherein the step of collecting the client system monitoring data further comprises the step of collecting the client system data from the point-of-view agents based upon the a point-of-view agent's perspective of its operating and runtime environment in addition to synthetic or observed client transactions.

15. The method of claim 10, wherein the step of identifying a deviant client system further comprises the steps of:
determining whether the acquired data in regard to a specific client system originated at an operating environment of the point-of-view agent reporting the deviant behavior;
determining whether multiple point-of-view agents reported similar deviant behavior; and
correlating diagnostic information related to network availability and performance from multiple agents.

16. The method of claim 10, wherein the step of coordinating the collection of the client system monitoring data acquired by the point-of-view agents further comprises the steps of the point-of-view agents collecting data through the execution of assigned jobs.

17. The method of claim 16, wherein the execution of jobs by point-of-view agents further comprises the steps of accounting for current system load, and awareness of the client system's operating environment.

18. The method of claim 17, wherein the accounting for current system load and awareness of the client system's operating environment comprises implementing point-of-view agents that have negligible impact on actively used client systems.

19. The method of claim 18, wherein respective point-of-view agents periodically request updated job assignment information.

20. The method of claim 19, wherein point-of-view agents with negligible impact on actively used systems can hibernate until needed.

21. The method of claim 10, wherein deviant client systems can automatically be detected and the commonalities between deviant systems and non-deviant systems can be determined.

22. The method of claim 21, further comprising the step of determining baselines for the purpose of assisting in detecting deviation within a client system.

23. The method of claim 22, wherein baselines are composed of environmental, numerical runtime, and runtime components.

24. The method of claim 21, further comprising the step of comparing each client system to a group baseline.

25. The method of claim 21, further comprising the step of determining the commonalities, and differences in commonalities between deviant and non-deviant client systems.

26. The method of claim 25, further comprising the step of determining the difference set between any two groups of commonalities.

27. A computer program product that includes a computer readable medium that is usable by a processor, the medium having stored thereon a sequence of instructions that when executed by a processor causes the data unit processor to execute the steps of:
coordinating the collection of the client system monitoring data acquired by the point-of-view agents;
confirming the validity of the acquired client system data;
assigning respective client systems to groups based upon runtime, environmental, and use criteria;
analyzing the acquired data in order to ascertain any commonalities that may exist between the data of differing client systems and differing groupings of client systems;
identifying a deviant client system in the event that the acquired data in regard to the client system determines that the client system behavior is deviant; and
initiating an alarm function that identifies the deviant client system.
